(19) United States
(12) Patent Application Publication
(10) Pub. No.: US 2007/0004391 A1
(43) Pub. Date: Jan. 4, 2007

(54) Method and apparatus for operating a value-added mobile data communication service on top of existing mobile telecommunications networks

(75) Inventor: Silvano Maffeis, Baden (CH)

Correspondence Address: LAW OFFICES OF BARRY N. YOUNG, 260 SHERIDAN AVENUE, SUITE 410, PALO ALTO, CA, 94306-2047, US

(73) Assignee: VIPERA, INC., a Delaware Corporation

(21) Appl. No.: 11/171,820

(22) Filed: Jun. 30, 2005

(51) Int. Cl. H04M 3/00; H04M 1/00

(52) U.S. Cl. 455/418

(57) ABSTRACT

A mobile data communications system and method affords data communications between mobile applications executing on wireless mobile devices and complementary applications hosted on remote application servers to provide access to various services, by using a communications protocol provided by said applications that runs on top of the basic data transmission service provided by conventional wireless mobile data operator services to which the mobile devices are connected. Mobile devices can download a variety of different mobile applications to afford access to a variety of different services and enterprise applications.

### BACKGROUND OF THE INVENTION

The usage of mobile data services such as SMS (Short Message Service) and MMS (Multimedia Message Service) offered by mobile telecommunications networks is increasing steadily. However, there are some drawbacks associated with these mobile data services. For instance, SMS is limited to 160 text characters; MMS is limited to multimedia content, and neither is well suited for performing business-to-employee or consumer-to-business transactions. Additionally, both SMS and MMS are expensive for mobile end users, offer only very rudimentary security mechanisms, and are controlled by telecommunications operators (Telco), meaning that application providers are generally forced to accept disadvantageous revenue sharing models where the Telco typically charges a substantial fee for conveying third party content through its SMS and MMS networks.

There is a need for more robust, more interactive, more flexible and lower cost mobile data services for the mobile subscriber than currently available services such as SMS and MMS offered by traditional mobile data services. Technological advancements such as the ubiquitous Internet, low-cost web server hosting, and programmable mobile phones that support the IP protocol make possible the implementation purely in software of alternative mobile telecommunications services, and the possibility of operating these services using current generation Telcos as data bearers. Satisfying this need and addressing the foregoing and other problems of existing mobile data communication services by providing alterative services are the ends to which the invention is directed.

### SUMMARY OF THE INVENTION

The invention addresses the foregoing and other problems with known mobile data services by providing a mobile data communications system and method implemented in software and that may be operated atop conventional Internet backbones and atop telecommunications systems such as GPRS, EDGE, UMTS, WLAN or WiMAX without the limitations of conventional mobile data services such as SMS and MMS.

In one aspect, the invention provides a system for communicating data over a mobile data communications network between a mobile device and a remote entity in which a mobile application and a connector application are provided on the mobile device, and a destination application that is complementary to the mobile application is hosted on the remote entity. The connector application on the mobile device establishes a network connection over the mobile data communications network between the mobile device and a peer server, and the peer server establishes another connection to the remote entity. The mobile application transmits data between the mobile device and the peer server using an application data transmission protocol provided by the mobile and destination applications that runs on top of a mobile data transport service provided by the mobile data communications network.

In accordance with more specific aspects, the mobile data communications system in accordance with the invention may include a user registration facility, a mobile data routing system, a mobile application provisioning system, a billing system, as well as an access control and security systems. The systems may be integrated with each other to afford a mobile application network system.

In another aspect, the invention affords a method of communicating data over a mobile data communications network between a mobile device and a destination application in which a first network connection is established over the mobile data communications network between the mobile device and a peer server, and another connection is established between the peer server and an entity hosting the destination application. Data is transmitted between a mobile application executing on the mobile device and the destination application hosted on the entity by using an application data transmission protocol provided by said mobile and destination applications that runs on top of a mobile data transport service provided by said mobile data communications network.

In still another aspect, the invention affords a method of communicating data over a mobile data communications network between a mobile device and a remote entity where a mobile application and a connector application are provided to the mobile device, and a destination application complementary to the mobile application is provided to the remote entity. A network connection is established over the mobile data communications network between said connector application on the mobile device and a peer server, and another connection is established between the peer server and the remote entity. Data is transmitted between the mobile device and the peer server using an application data transmission protocol provided by said mobile application and said destination application that runs on top of a mobile data transport service provided by the mobile data communications network.

### BRIEF DESCRIPTION OF THE DRAWINGS

FIG. 1 is a block diagram of a system of the type in which a mobile application network operator (“MANO”) according to the invention may be embodied;

FIG. 2 is a diagrammatic view showing an example of mapping of virtual network addresses to Internet DNS host names of peer servers; and

FIG. 3 is a schematic diagram illustrating a system embodying a mobile application network operator in accordance with the invention.

### DETAILED DESCRIPTION OF PREFERRED EMBODIMENTS

The invention will be described herein in functional terms, and may be realized by any combination of software and hardware. While the invention is especially well adapted to data communication systems and methods in an Internet environment, and will be described in that context, this is illustrative of only one utility of the invention. As will become apparent, the invention has application to a number of different areas, and the embodiments described herein are merely exemplary of the invention.

General

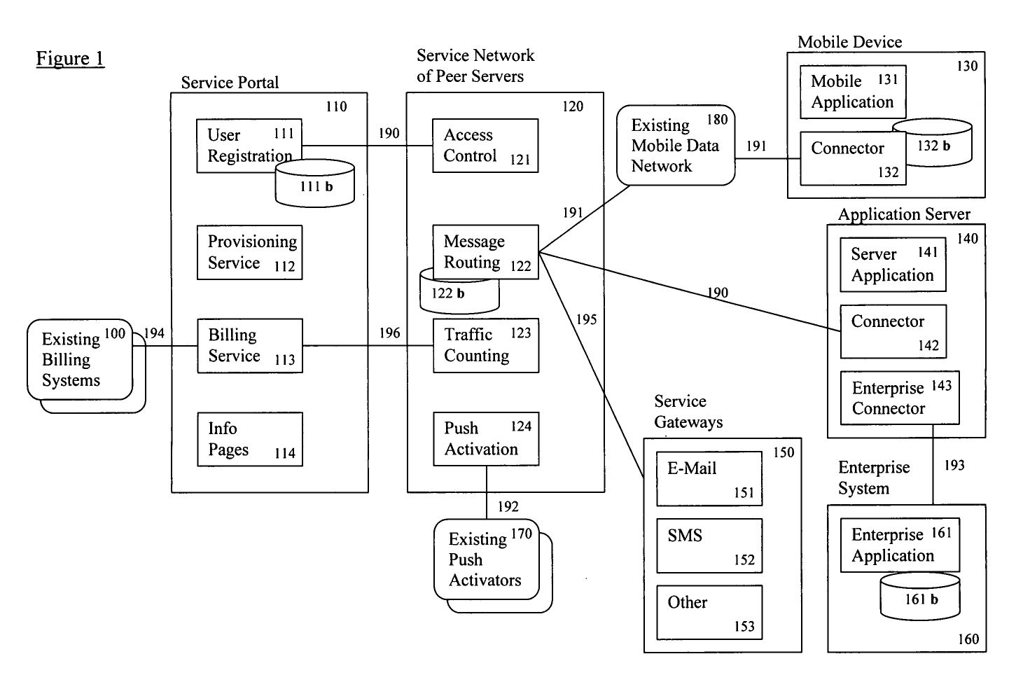

FIG. 1 is a block diagram of a system in which the invention may be embodied. Referring to FIG. 1, in accordance with a preferred embodiment, the invention affords a system and method that are referred to in this specification as a mobile application network operator (“MANO”), and that may comprise a service portal 110, a service network of peer servers 120, a plurality of wireless mobile devices 130, a mobile data network 180, one or more application servers 140, one or more enterprise systems 160, and service application gateways 150. The MANO of FIG. 1 may allow a software application installed on one mobile device 130 to send data to applications installed on other mobile devices 130 or to applications on one or more application servers 140. Similarly, applications installed on application servers 140 may send data to applications installed on mobile devices 130.

The service portal 110 may be coupled to the service network of peer servers 120 via a communication medium 190 to inform the service network of peer servers 120 of new user registrations and of deleted user registrations. The service portal 110 also may be coupled to the service network of peer servers 120 via a communication medium 196, which may be the same as or different from communications medium 190, for network usage information from the peer servers 120 to allow the service portal 110 to bill end users for application data traffic generated on the service network 120.

The mobile devices 130 may be coupled to the service network 120 via a conventional mobile data network 180. Application servers 140 may be coupled with the service network 120 via communication medium 190. Application servers 140 can optionally be coupled with enterprise systems 160 via a communication medium 193, e.g., to query and update enterprise databases 161b. The service network of peer servers 120 may access Internet or other network services such as e-mail via service gateways 150 and a communication medium 195. The service network 120 may initiate applications on mobile devices 130 by issuing push notifications through push activators 170, which may be of known form, and via a communication medium 192.

Service Portal

Because the invention offers a mobile operator service to mobile users, service portal 110 may allow system users to register as end users of the MANO. Such end users may comprise owners of mobile devices 130 as well as owners of application servers 140. The service portal 110 may comprise a plurality of facilities 111-114 that perform the indicated functions in FIG. 1, and may be in the form of one or more web applications. Those web applications are preferably implemented according to the standards of the Java-2 Enterprise Edition (J2EE) or Microsoft .NET platform. The service portal 110 can be deployed to a J2EE server such as IBM WebSphere, or to a Servlets engine such as Apache Tomcat, or to a Microsoft .NET server, or to an internet web server product such as Apache HTTP server. The service portal 110 may be implemented in software and installed on conventional computers running standard operating systems, such as the Microsoft Windows, Linux or Sun Solaris operating systems.

The user registration facility 111 may be implemented as a web server having an installed web application, such as, for example, in HTML, PhP, JSP, or ASP. The web application may present a user registration form to a registering end user for the user to provide certain information, such as name, address, age, and mobile phone number. Once the user has entered this information into the web form, which may be displayed in the user's web browser (e.g., Netscape, Internet Explorer, or Firefox), the form is submitted by the end user and processed by the user registration facility 111. The data entered by the end user may be validated and, upon successful validation, the data may be stored in a user registration database 111b and a MANO virtual address may be assigned to the end user. In this manner, a user account may be created by the service portal 110.

The user registration facility 111 may delete a registered user account, as for instance when the end user has exhausted all of his credit as stored, for example, in the billing service facility 113, or when the end user has been inactive for too long, or when the administrator of the MANO decides to close the account due to an activity performed by the end user. At selected time intervals, the user registration facility 111 may connect to the access control facility 121 of the service network of peer servers to inform the access control facility 121 of any newly created user accounts, as well as to delete any obsolete user accounts.

After successful registration with the user registration facility 111, a mobile end user needs to configure the network connection on his mobile device 130, and then may download a mobile application 131 compatible with the MANO. Device configuration as well as application download are preferably performed via the provisioning service 112 of the service portal. For this, the end user may open another service portal 110 data entry form in his or her web browser to provide his or her mobile phone number as well as information about the mobile phone model and about the mobile data network 180 to which the device 130 is connected. After submitting the data entry form, the provisioning service 112 can send a configuration SMS to the mobile device. The content of the configuration SMS may be compliant with the WAP Provisioning Architecture Specification [WAP-PROV]. The configuration SMS may contain GPRS (General Packet Radio Service in GSM networks) configuration settings such as the Internet address of the APN (GPRS Access Point Node), APN port number, APN user name and password, session type and authentication type. The mobile device 130 creates a new mobile connection profile and stores the received configuration settings. Now the mobile device 130 is capable of using the mobile data network 180 service (e.g., GRPS) to send and receive data to and from the MANO.

Next the mobile user may install a MANO mobile software application 131 on the mobile device 130. Such mobile application 131 could be, for example, a game, a mobile banking software application, a picture messaging application, an instant messaging application, or a voice-over-IP application, to name a few. To install a mobile application 131, the end user may open another service portal data entry form in his or her web browser and choose a mobile application 131 from a catalog of available applications. The web browser can be a product such as Internet Explorer, Netscape or Firefox installed on a PC, or it can be a HTML, WML or XHTML micro browser installed on the mobile device 130. The end user chooses a mobile application and submits the data entry form to the provisioning service 112. The provisioning service may determine the device type and model by analyzing a user-agent HTTP header field supplied by the mobile device 130. The provisioning service may then supply the selected mobile application 131 with matching characteristics (screen size, memory size, etc.) for the mobile device 130. The installation is preferably carried out by the provisioning server 112 either by sending the mobile software application 131 to the mobile device 130 via WAP Push [WAP-PUSH], or by the mobile user opening a download URL (Uniform Resource Locator) from the WAP or HTML browser available on the mobile device 130.

Application providers that make available mobile applications 131 and/or server applications 141 to the users of the MANO may be compensated for their mobile applications. The billing service 113 is a facility capable of charging end users, for example, for the download of mobile applications 131, for the data traffic generated between certain mobile applications 131 and server applications 141, or for the time they are connected to the MANO. The billing service 113 may offer to end users an optional subscription model which will automatically charge the mobile users credit card every month, for example. The billing service 113 may also support both a prepaid and a postpaid model. The end user can be charged, for example, through his or her credit card, or through the phone bill issued by the existing mobile data network 180 operator, or by premium-SMS, or by a prepay system. For this purpose, the billing service 113 may interface with external existing billing systems 100 such as PayPal, WorldPay, Premium-SMS services, prepay scratch card systems, or the billing system of the existing mobile data network 180 operator. A variety of different communication media may be used. For example, the HTTP POST or the SOAP protocol can be used for interfacing to the PayPal system.

The billing service 113 uses communication medium 196 to request traffic information from the traffic counting facility 123. That information reveals the amount and the type of MANO related data traffic the user has generated during a certain period of time. The billing service 113 uses this information to charge the end user for the usage of the MANO service. The billing service 113 may transfer MANO revenue to the aforementioned application providers, e.g., by transferring funds to the application providers credit card or bank account.

The Info Pages 114 may be a set of service portal web pages encoded, for example, in HTML, PhP, JSP, or ASP. The Info Pages may display information to the end user, such as the credit remaining in the billing service 113 for the user, data transmitted during the current time period, subscription level (e.g., “bronze”, “silver” or “gold” account) of the end user, and so forth.

Service Network of Peer Servers

The service network of peer servers 120 may comprise one or more networked computers running peer server software applications. The service network is responsible for managing the data flow from one mobile device 130 to another mobile device 130, from a mobile device 130 to an application server 140, from an application server 140 to a mobile device 130, or even from an application server 140 to another application server 140. The service network of peer servers software applications may be implemented according to the standards of the Java-2 Enterprise Edition (J2EE) or Microsoft .NET platforms. The peer servers 120 may be either standalone applications or application packages that can be deployed to a J2EE server such as IBM WebSphere, or to a Servlets engine such as Apache Tomcat, or to a Microsoft .NET server. The peer servers are preferably implemented in software, and may be installed on conventional computers running the Microsoft Windows, Linux or Sun Solaris operating systems. The preferred embodiment is a standalone Java application that can be installed and operated remotely, without requiring any physical access to the computers running the peer servers 120. The peer servers 120 can also be installed on computers hosted by an ISP (Internet Service Provider). As shown in FIG. 1, and as will be described, the peer servers may comprise a plurality of facilities 121-124, such as software applications, that perform the functions indicated.

The access control facility 121 of the peer servers 120 ensures that only mobile users that have successfully registered with the user registration facility 111 of the service portal 110 can access the MANO. The access control facility 121 prevents unauthorized users from accessing the MANO service. The access control facility 121 may implement blacklisting or other access control functions to prevent unauthorized or unwanted users, computers or networks from accessing the MANO system.

The message routing facility 122 forms a central part of the peer server 120. The message routing facility 122 receives mobile data messages from mobile devices 130 and determines whether the message can be forwarded to the destination application by this peer server 120, or whether the message first needs to be routed to another peer server 120. The message routing facility 122 may use a persistent (non-volatile) database 122 b to store messages which cannot be transmitted to their destination, for example, because the destination entity (a mobile device 130 or application server 140) is not turned on at that time, or because the destination mobile device 130 has no network coverage at that time. Typically, when a message routing facility 122 receives a message from a mobile device 130 or from an application server 140, it stores the message in message routing database 122b. When the destination of the message connects to the message routing facility 122, the message may be read from message routing database 122b and transmitted to the destination (130 or 140). Upon successful transmission, it may be deleted from message routing database 122b.

The traffic counting facility 123 maintains up-to-date information about the data traffic generated by each user of the peer servers 120. As mentioned before this information is then used by the billing service 113.

The push activation facility 124 is capable of remotely starting a mobile application 131 when new message data intended for that particular mobile application 131 has arrived at the message routing facility 122 while the destination mobile application 131 is not running. The push activation facility 124 may use push activators 170 such as WAP-Push, SMS or HTTP to contact the destination mobile device 130. For example, a mobile application 131 installed on a mobile wireless device such as a RIM BlackBerry device can be remotely started by establishing an HTTP connection from a server to the mobile BlackBerry device. Also, a mobile Java application 131 installed on a Nokia or Sony-Ericsson mobile phone may be activated by a server by sending an SMS message to the mobile phone. Push activation can be implemented using the J2ME-MIDP Version 2 “PushRegistry” mechanism [MIDP2]. The push activation facility 124 may use a variety of communication media, collectively denoted as 192, to issue push activations via the push activators 170.

Mobile Devices

The mobile devices 130 may be wireless mobile phones, for example, a Nokia 6600 or a Sony-Ericsson K700i, which host software written in Java or in another programming language that can be loaded by the end user. Alternatively the mobile device 130 may be a personal digital assistant (PDA) such as the devices manufactured by PalmOne, Inc., a Pocket PC such as a Hewlett-Packard IPAQ running the Microsoft Windows operating system, a handheld device running the Linux operating system, a RIM BlackBerry device, or it may be a device running the Qualcomm BREW platform. The mobile device 130 is preferably equipped with a wireless communication capability such as GPRS, EDGE, UMTS, WiMAX or WLAN.

Mobile applications 131 specifically adapted for the MANO platform can be installed onto and hosted by the mobile devices 130. Such installation may occur via the provisioning service 122 as explained above, or the application can be transmitted to the mobile device 130 via infrared, Bluetooth, e-mail, wireless LAN, synchronization cable or any other type of communication medium. Mobile applications 131 crafted for the MANO platform may provide a service to the end user such as, for example, games, mobile electronic banking, order taking, sending and receiving photo images, locating nearby restaurants, or issuing or receiving alarm notifications.

Mobile applications 131 are preferably in a programming language such as Java, C, C++, C#, Visual Basic, BREW, etc. In developing mobile applications 131 in one of the aforementioned programming languages, the developer of the mobile application 131 may use a software platform or development kit such as Java-2 Micro Edition (J2ME), Java-2 Standard Edition (J2SE), PalmOS Software Development kit, Symbian OS Software Development kit, BREW Software Development kit, Linux, or any Microsoft Pocket PC developers kit.

In order to use the MANO service, the mobile application 131 uses a software connector application 132. The connector 132 may be crafted specifically for the MANO service and realized in the form of a software library or an operating system device driver. For example, if the J2ME platform is used to develop a mobile application 131, then the connector 132 may be supplied to software developers in the form of Java source code or Java CLASS files that can be imported into a J2ME MIDlet application. If the Symbian OS platform is used to develop a mobile application 131, then the connector 132 may be supplied to software developers in the form of Symbian C++ source code or in the form of a Symbian OS DLL shared library.

The connector 132 functions to establish and maintain a network connection with one or more peer servers 120 preferable using the TCP/IP protocol. The network connection is established through an existing conventional wireless mobile data network 180, preferably using TCP/IP protocol, such as, for example, a GPRS, EDGE, UMTS or WiMAX network. These network services are not provided or operated by the MANO but by telecommunications companies such as Vodafone, Sprint, or Verizon that operate the mobile data network. GPRS, EDGE, UMTS and WiMAX are all IP (Internet Protocol) based wireless networks, and it is preferred to use end-to-end IP connectivity. Alternatively, however, embodiments may use other data networks not based on the IP (Internet Protocol).

In case of an IP-based mobile data network 180, the mobile data network operator will assign an IP (Internet Protocol) address to the mobile device 130 when the device is turned on or when the device establishes a network connection. Such IP (Internet Protocol) addresses are usually assigned using a dynamic addressing scheme such as DHCP (Dynamic Host Configuration Protocol). The invention has no requirement of using fix IP (Internet Protocol) addresses, and may operate also in an environment where IP (Internet Protocol) addresses are assigned dynamically.

The MANO functions as a layer of software running on top of the mobile data networks 180. Also, the invention only requires basic data transportation services such as GPRS from mobile data network 180 operators (e.g., Vodafone, Sprint, or Verizon, etc.). Advantageously, the invention does not require any value-added services such as SMS, MMS, mobile e-mail and so forth from the mobile data network 180 operators. Rather, as will be described, the mobile applications 131 and server applications 141 may be tailored to avoid the limitations and disadvantages of typical value-added services provided by mobile data networks.

The mobile data network 180 operators may bill the MANO end user for the raw data traffic transported over their existing mobile data networks. For example, a mobile data network operator might charge $1 per megabyte of data transmitted through its GPRS network. Actual pricing might vary considerably from that figure. A mobile data network operator might offer a flat fee subscription model allowing end users to send and receive arbitrary amounts of GPRS data at a flat monthly fee. In addition to the billing imposed by mobile data network operators, the MANO may also charge end users through the aforementioned billing service 113. The MANO may charge for usage of its value-added services operated atop the existing mobile data network 180. As noted previously, such value-added services may include picture messaging, mobile e-mail, mobile games, mobile news, mobile banking, mobile presence services, mobile alerting, and so forth.

The connector 132 may use any of the TCP/IP, SSL, HTTP, HTTPS or UDP Internet protocols to connect to the message routing component 122 of the peer server(s) 120. These Internet protocols are operated on the mobile data network 180. The mobile data network 180 operator allows the connector 132 to establish IP connections to the peer servers 120, which may be located on the public wire-line Internet. Alternatively, peer servers 120 could be installed also in private networks, for example in private networks or in data centers of a bank or other enterprise, or a telecommunications company.

The connector 132 may detect when the network connection to the message routing facility 122 fails due to lack of network coverage, due to the mobile device 130 roaming from one mobile network 180 to another, due to a technical problem such as a failed Internet backbone or link, or a failed peer server 120. In the event of such a failure, the connector 132 preferably tries to re-establish the connection to the message routing facility 122. The connector 132 may try to re-establish the connection at time intervals determined by a conventional retry-algorithm such as exponential back-off. Re-establishing a failed network connection can be done either transparently without involving the mobile end user, or by seeking permission or advice from the end user as by presenting a pop-up window on the mobile device 130 screen.

In case of a network failure, the connector 132 may store outgoing data (this is data the mobile application 131 wants to send to another application) in a connector database 132b, for example, non-volatile memory data store. This ensures the data is not-lost even when the network failure persists during a long time period, and the device is switched off and on during that time period. As soon as the connector succeeds in re-establishing a network connection to the message routing facility 122, the data stored in the connector database 132b may be delivered to the message routing facility 122 and deleted from the connector database 132b. To ensure delivery, the connector 132 and the message routing facility 122 may engage in a conventional reliability protocol, such as by using delivery acknowledgements and sequence numbers.

The connector database 132b can be the Record Management Store (RMS) database included in the J2ME platform, or the database service of the Symbian OS, Palm OS, or Windows Mobile platforms, a commercial database for mobile devices, or an ad-hoc data storage mechanism implemented on top of the file system of the mobile device 130.

Application Servers

A mobile application 131 such as a mobile banking application, will need to access a complementary server application 141 hosted on an entity such as an application server 140. This server application 141 acts as a complement to the mobile application 131. The application server 140 may use PC, server or mainframe computer hardware. An application server software product such as IBM WebSphere, or Apache Tomcat, or Microsoft .NET can be loaded onto the application server 140 computer.

As an example, the mobile application 131 may provide an online banking user interface to the end user. The complementary banking server application 141 may receive the data transmitted by the mobile application 131 and access the backend systems of the bank to perform banking transactions, such as issuing wire transfers, checking account balances, etc. The mobile application 131 may create, for example, a data message with the text “show account balance” and with a MANO receiver address “041-00001-0000001” and pass that message to the MANO connector 132 which is linked with the mobile application 131. The address “041-00001-0000001” corresponds to the MANO receiver address of the mobile banking server application 141. The connector transmits that message to the message routing software component 122 of the service network of peer servers. The message routing facility 122 then forwards that message to the mobile banking server application 141. The server application now may use one or more enterprise connectors 143 to connect to one or more backend enterprise systems 160 of the bank. Such backend systems include, for example, databases, transaction servers, directory servers, information systems, etc. With the information received from the enterprise systems 160, the server application 141 creates a MANO response message that is returned to the mobile application 131. The response message includes the data requested by the mobile application, for example, the account balance of the user, and is addressed to the MANO address of the mobile application, for example, “041-00001-0000002”.

The enterprise connector 143 can be a library provided by the enterprise system 160 or enterprise application 161 manufacturers, or it can be a SOAP WebServices client, or it can be a Java-J2EE connector (JCA), or it can be a Java JDBC connector, or it can be a Microsoft ODBC or an Oracle connector. The enterprise connector 143 may use a network connection 193 to the enterprise system 160. That connection 193 may be established either by the enterprise connector 143 itself or by the server application software 141 into which the connector 143 might be installed.

The connector 142 used by server applications 141 can be different from the connector 132 used by mobile applications 131. The mobile connector 132 may use a data encoding format and communication method 191 optimized for mobile data networks. On the other hand, the server connector 142 may use a data encoding format and communication method 190 optimized for server applications on wire-line networks. In the preferred embodiment, the application server connector 142 is implemented as a WebServices SOAP client library which accesses the message routing facility 122 via a WebServices Definition Language (WSDL) interface.

Enterprise Systems

Enterprise systems 160 may comprise systems used by corporations such as banks, airlines, Telcos, etc., to support their business processes. For example, a bank may use an enterprise system 160 with one or more enterprise applications 161 for storing bank account information, for performing accounting activities, for issuing transfers of funds, for customer relationship management (through systems 160 such as SAP or Siebel), and so forth. Usually enterprise applications are connected to enterprise application databases 161b, such as are available, for example, from Oracle, Sybase or MySQL.

Mobile solutions such as mobile banking are typically developed without modifying the existing enterprise applications 161. This is a software design practice which leads to server applications 141 being developed as “gateways” between the mobile applications 131 and the enterprise applications 161.

Application Gateways

The invention can transmit mobile data messages between mobile applications 131 and between server applications 141 hosted on a variety of different types of entities. A connector 132 or 142 on each entity is used for this purpose. The MANO system also may include service application gateways 150 to allow the transmission of data to external destinations which are not equipped with a connector 132 or 142. The message routing facility 122 may detect that a MANO mobile data message is to be sent to such an external destination, and forward the MANO mobile data message to an application gateway 150. The application gateway may convert the MANO mobile data message to Internet SMTP e-mail format 151, orto SMS 152 format, or to another format 153 such as NNTP (Network News Transfer Protocol) or RSS (Rich Site Summary). The information which is part of the MANO mobile data message is then transmitted to its destination via said e-mail, SMS or other communications protocol.

The application gateways 150 process not only outbound messages but also inbound messages. For example, an end user can send a regular Internet e-mail to a certain e-mail address. The MANO e-mail application gateway 151 will receive the e-mail through the Internet IMAP or POP protocol, transform it to a MANO mobile data message format, and transmit it on top of the mobile data network protocol to another mobile application 131 or to a server application 141.

In the preferred embodiment, the application gateways are software applications developed in Java or in a Microsoft Windows programming environment. The application gateways 150 may be operated as standalone applications, or as Unix daemons, or as Microsoft Windows services, or as J2EE applications. Communication medium 195 is used to carry data between the message routing facility 122 and the application gateways 150. Application gateways 150 may use the connector 142.

In an alternative embodiment, an application gateway 150 can reside inside a peer server 120. A conventional communication model such as local method invocation or shared memory message passing may be used instead of communication medium 195.

Communication Meduim 190, 195, 196, 197

On the communication links interconnecting the various elements of FIG. 1, it is preferable to use the Simple Object Access Protocol (SOAP) standard of the Word Wide Web Consortium (W3C) for performing server-to-server communication over wire-line networks. For the SOAP transport protocol, TCP/IP, HTTP, HTTPS or e-mail may be used.

Communication Medium 191

Preferably, SOAP is not used as communication medium 191 between the mobile connector 132 and the message routing facility 122, because SOAP incurs substantial data communication overhead and data service costs. These might not be tolerated by the end-user. Rather, it is preferred to employ a light-weight, compressed asynchronous messaging protocol for communication medium 191, such as, for example, WAP Binary XML or an ad-hoc binary protocol. As a transport protocol, the preferred embodiment may offer a choice between TCP/IP, HTTP, and HTTPS. Alternatively, SOAP may also be used for communication medium 191. In this case, communication medium 191 and 190 will be the same.

Communication Medium 192

The push activation facility 124 may transmit a push request to a push activator 170 by issuing, for example, an HTTP POST request to a specific service URL, or by issuing a SOAP call to a certain WebService URL. This is the case when working with known push activators 170 such as Clickatell (www.clickatell.com) or BlackBerry MDS (www.blackberrv.com). Other suitable push activators that may be used might require other protocols such as SMPP (Simple Messaging Peer to Peer Protocol) or XMS (Extended Messaging Protocol) or UCP (Universal Communication Protocol).

Virtual Addressing

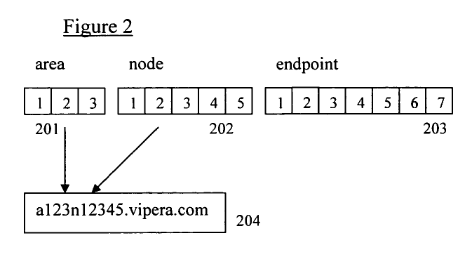

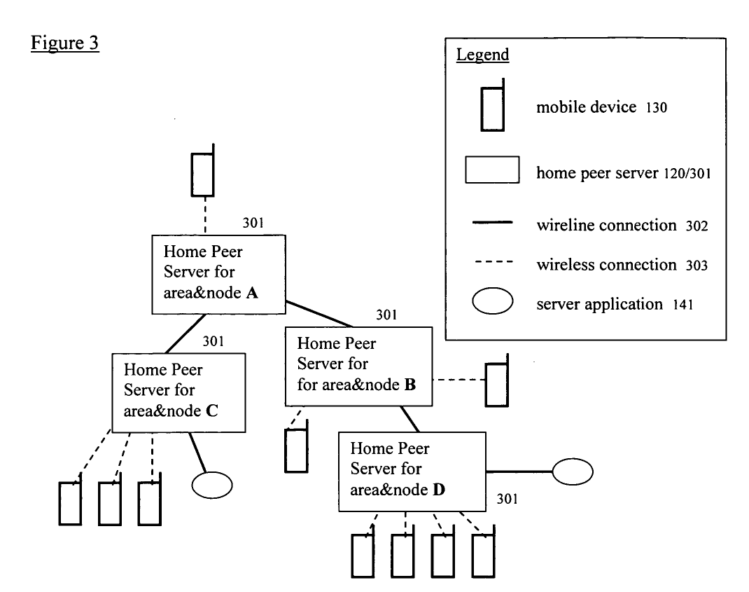

Referring to FIG. 2 and FIG. 3, in accordance with the preferred embodiment of the invention, each mobile application 131 and each server application 141 may be assigned a so-called MANO virtual address. The virtual address may have a form similar to a phone number, but has no relation with any phone number assigned to the device 130 by the mobile data network 180 operator, such as Vodafone. Rather, the invention uses virtual addresses to uniquely identify mobile users and server applications 141 in the MANO service.

MANO addresses are preferably assigned when a user registers with the user registration facility 111. The preferred embodiment may use 15 digit virtual addresses, where the first 3 digits denote an area 201 where the peer server 120 resides, the next 5 digits denote a node 202 where the peer server 120 resides, and the last 7 digits denote an endpoint 203.

Area 201 and node 202 of the address together uniquely identify a certain peer server 120. The endpoint 203 portion of the address uniquely identifies a mobile user or server application that uses this peer server 120 as its home peer server 301.

Since the mobile connector 132 preferably uses the IP (Internet Protocol) to communicate with the message routing facility 122, the scheme illustrated by FIG. 2 may be used to map the end user's MANO virtual address to the fully qualified Internet host name 204 of the home peer server 301. This fully qualified Internet host name 204 is then passed to the Internet Domain Name Service (DNS) to obtain the IP (Internet Protocol) address of the home peer server 301.

The address mapping method may comprise the following process. First an alphabetic character such as the letter “a” may be used as the first character of the virtual address to designate the area portion of the address. Then, the area portion of the MANO virtual address, e.g., “123” may be appended to the first character. Next, a second alphabetic letter such as “n” to designate the node may be appended to the area portion, and the node portion of the MANO virtual address, e.g., “12345” may be appended following the second alphabetic letter. A dot “.” may be appended to the node portion, and finally the Internet domain name of the MANO operator, e.g., “vipera.com”, may be appended to complete the virtual address.

In the example illustrated in FIG. 2, the end user MANO virtual address “123-123435-1234567” will be converted to the home peer server 301 Internet address “a123n12345.vipera.com”.

Peer Server Network Topology

Referring to FIG. 3, in accordance with a preferred embodiment of the invention, to ensure high scalability of the MANO service network 301, it is desirable to distribute a large user base to many peer servers 301. Peer servers 301 may be interconnected with each other by means of communication medium 190. A conventional routing protocol, such as Distance Vector Routing, may be implemented by the message routing facility 122 to route MANO messages between peer servers when the sender of the message is connected to one peer server but the receiver of the message is connected to another peer server. A MANO message might pass through one, two, or more peer servers 301 on its way from sender to destination.

A service network 120 (FIG. 1) might comprise only one peer server 120, with all mobile devices 130 and application servers 140 connecting to that single peer server 120. Alternatively, it might comprise many peer servers interconnected with each other in a tree, graph or other network topology.

When a message routing facility 122 receives a MANO data message from a mobile device 130 or from an application server 140, the message routing facility 122 inspects the destination virtual address of the message. Each peer server has a unique area 201 and node 202. If the destination virtual address carries the same area 201 and node 202 number designations as the peer server, then the message routing facility 122 delivers the message to the destination application. Otherwise the message routing facility 122 may consult a conventional routing protocol to determine to which peer server 120 to deliver the message. The next peer server will also look at the area 201 and node 202 numbers and deliver the message to the destination application or to another peer server.

An area 201 may denote a geographic region such as a country or a state within a country. The node 202 denotes a particular peer server within the given area 201. Alternatively, an area 201 might denote a company or a division within a company or other enterprise, or might denote an interest group, a particular user group, or a subnet.

While the foregoing description has been with reference to preferred embodiments of the invention, it will be appreciated that changes to these embodiments may be made with out departing form the principles and spirit of the invention, the scope of which is defined by the appended claims.

1. A system for communicating data over a mobile data communications network between a mobile device and a remote entity comprising:
a mobile application and a connector application both adapted to run on said mobile device;
a destination application that is complementary to said mobile application and adapted to run on said remote entity; and
a peer server connected to the mobile data communications network, said connector application being adapted to establish a network connection over said mobile data communications network between the mobile device and the peer server, and said peer server being adapted to establish another connection to the remote entity;
said mobile application transmitting data between said mobile device and said peer server using an application data transmission protocol provided by said mobile and destination applications that runs on top of a mobile data transport service provided by said mobile data communications network.

2. The system of claim 1 further comprising a message routing facility in the peer server that determines an address of the remote entity and manages data transmitted between the mobile device and the remote entity.

3. The system of claim 2, wherein said peer server is part of a service network of peer servers, and said peer server connects to said remote entity via another peer server of said service network.

4. The system of claim 3, wherein said network of peer servers comprises peer server software applications running on one or more computers.

5. The system of claim 1, wherein said peer server comprises a message routing facility that receives data messages and manages data communications between said remote device and said destination application.

6. The system of claim 1 further comprising a data store for storing data messages when said network connection is unavailable.

7. The system of claim 6 further comprising a push activation facility for pushing data messages to said mobile device when data for the mobile device becomes available.

8. The system of claim 1, wherein said remote entity comprises one of an application server or another mobile device that hosts said destination application.

9. The system of claim 8, wherein said application server provides another connection to an enterprise application, and said destination application communicates with said enterprise application via said other connection.

10. The system of claim 1 further comprising a service portal having a registration facility for registering mobile devices and remote entities, and a provisioning service for configuring mobile devices for operation on said system.

11. The system of claim 10, wherein said provisioning service is adapted to download said mobile application to said mobile device.

12. The system of claim 10 further comprising a web browser that enables selection of said mobile application from a plurality of available applications, and the provisioning service determines characteristics of said mobile device and downloads said selected mobile application with matching characteristics.

13. The system of claim 10, wherein said peer server comprises a traffic counting facility and said service portal comprises a billing service that communicates with said traffic counting facility for billing users for use of said system.

14. A method of communicating data over a mobile data communications network between a mobile device and a destination application comprising:
establishing a network connection over the mobile data communications network between the mobile device and a peer server;
establishing another connection between the peer server and an entity hosting the destination application; and
transmitting data between a mobile application executing on the mobile device and the destination application hosted on said entity, said transmitting comprising using an application data transmission protocol provided by said mobile and destination applications that runs on top of a mobile data transport service provided by said mobile data communications network.

15. The method of claim 14 further comprising storing data locally at one or both of said mobile device and said peer server at times when the network connection is unavailable.

16. The method of claim 14, wherein said entity comprises another mobile device and said remote application comprises another mobile application executing on said other mobile device.

17. The method of claim 14, wherein said entity comprises an application server and said destination application comprises an application complementary to said mobile application.

18. The method of claim 17 further comprising connecting said application server to the peer server via a wire line network, and sending data to and receiving data from said peer server via said wire line network.

19. The method of claim 14, wherein there are a plurality of peer servers having unique network addresses at nodes in different network areas, and wherein the method comprises determining at said peer server receiving data from the mobile device the address of another peer server to which said entity is connected, and routing the data to said other peer server.

20. The method of claim 19, wherein said network addresses are virtual addresses assigned upon registering mobile devices and entities on the network.

21. The method of claim 20, wherein said peer server activates the mobile application when data becomes available for said mobile device, and pushes the data to the mobile device.

22. A method of communicating data over a mobile data communications network between a mobile device and a remote entity comprising:
providing to the mobile device a mobile application and a connector application, and providing to said remote entity a destination application that is complementary to said mobile application;
establishing a network connection over said mobile data communications network between said connector application on the mobile device and a peer server, and establishing with said peer server another connection between the peer server and the remote entity; and
transmitting data between said mobile device and said peer server using an application data transmission protocol provided by said mobile application and said destination application that runs on top of a mobile data transport service provided by said mobile data communications network.

23. The method of claim 22 further comprising remotely installing software applications on said peer server, said software applications comprising a message routing facility that manages data messages transmitted between the mobile device and the remote entity, and an access control facility that controls access to the peer server by said mobile device and said remote entity.

24. The method of claim 22, wherein said providing said mobile application and said connector application to the mobile device comprises downloading said applications to said mobile device.

25. The method of claim 24, wherein said remote entity comprises an application server hosting said destination application, and the method further comprises connecting said application server to an enterprise application to enable access by said mobile device to said enterprise application.
